(19) United States
(12) Patent Application Publication
(10) Pub. No.: US 2008/0296240 A1
(43) Pub. Date: Dec. 4, 2008

(54) Commemorative sports banner display and organizer

(76) Inventor: Ethel Geraldine Napier, Houston, TX (US)

Correspondence Address: Ethel Geraldine Napier, 17715 Wild Willow Lane, Houston, TX, 77084, US

(21) Appl. No.: 12/154,958

(22) Filed: May 29, 2008

Related U.S. Application Data
(60) Provisional application No. 60/932,081, filed on May 29, 2007.

(51) Int. Cl. A47F 7/06; G09F 17/00; A47G 1/16; A47G 1/06

(52) U.S. Cl. 211/30; 40/604; 248/466; 40/700

(57) ABSTRACT

An apparatus; banner or plaque that is designed for holding and displaying Sports Caps, Photographs, Awards or other collectibles on a vertical plane. The apparatus includes tabs on top at either side to secure apparatus to a vertical plane. The soft display frame is produced by a transparent material in shape and size desired, that has been edged with a flexible material and permanently secured by the edges to the base of banner on 3(three) sides. This opening allows entry for items desired to be inserted securely. An attachment mechanism for the cap is a single strap, which is secured at both sides to base. Strap is connected at such points; as to allow the remainder of the strap to fall loosely to form a U shape. To secure the cap it is needed to fold the cap in half, from back to front; so that the back of the cap is nestling within the front of the cap and brim, and inserting the cap between base of banner and strap. The strap wraps around the front of the cap at the location the brim and top of the cap are joined. In this manner the cap is hung securely allowing easy viewing of cap, and will not cause any damage to cap being displayed. Using the design of the transparent display window and U shaped strap formations; a variety of other banners can be produced.

### BACKGROUND OF THE INVENTION

1. Field of the Invention

In general, the present invention relates to a display devices for displaying and storing a cap when the cap is not being worn. However, immediate access to baseball cap is accessible with ease. More notably, the present invention promotes easy storage, easy display, and versatility in its use and creates a personal trophy, by use of displaying various collectibles and memorabilia upon vertical planes. Furthermore, a cap and varied memorabilia can be changed easily to increase its use for future changes in uniform, or replaced with items of interest by the end user.

2. Description of the Prior Art

Since the beginning of sports and the development of the baseball cap the sports memorabilia industry has grown to gigantic proportions. Sales of any items with the sports theme have become a large part of this multi-billion dollar industry. These sales may includes; caps, shirts, foam pointed fingers, baseball cards, bats, cups, scarves, sweat suits, the list is endless. Baseball caps, especially, have become increasingly popular. Consequently, it is not uncommon for a person to own several caps as part of their wardrobe and/or their collection.

This movement with the sports industry has stimulated the kids baseball leagues, and school interests in baseball teams and players. Unfortunately, at present there is no satisfactory display, which can be used for everyday use and as a “trophy” for participation and acknowledgement later. Finding the cap needed for a game for a player can be extremely frustrating for all involved. This display allows one to store a cap in view, and is a daily reminder of their participation and achievements.

Normally an owner of numerous baseball caps may take the time to fold each cap neatly, placing one cap unto another. However, this is not the case with the millions of children that participate in sports. Neatness is not necessarily their strong point. Urgency to meet game time and finding ones cap may be a frustrating moment for some. Although, baseball caps require a minimum amount of space and the brims of each of the hats needs protected. A problem occurs when placing one cap on top of the other; the only visible cap is the one at the top. Accordingly, if a person is looking for one specific cap, the stack must be shuffled through until the desired cap is found.

This also allows storage of other collectibles with the use of the optional back pocket.

The Following U.S. Patents Pertain to Structure Design as Types of Plaque or Shelf Displays, Storage for Preservation of Cap, or Displays Structure Design that Makes Use of a Clamp or Clip for Support of Caps
U.S. Pat. No. 5,845,778; issued Dec. 18, 1997 to Hickey, Jr, titled “Hat Display Structure” design is to provide a display and to preserve an item of memorabilia in a sturdy and attractive manner. This relates to the storage of a single baseball cap that protrudes forward from structure and is covered with a transparent cover. However, it is designed for visual pleasure and preservation, not for daily use.
U.S. Pat. No. 5,480,073, issued Jan. 2, 1996 to LaManna titled, “Cap Holder Apparatus”, is a plaque like structure that; a plurality of clamp members project from the top surface of the base assembly, which secures the bill of the cap by a clamp member. This designs main use is for storage, no visibility of the front of the cap is possible, and there is no memorabilia display.
U.S. Pat. No. 5,813,546, issued Sep. 29, 1998 to Wilson/Catalano; titled “Cap display apparatus” is a plaque like structure that mounts on a wall and the cap extends forward with a transparent cover. The cap is held within the cavity created by the specially shaped hollow form. The bill of the cap displayed protrudes forward and does not allow for easy access for daily use, has no memorabilia display.
U.S. Pat. No. 5,240,123, issued Aug. 31, 1993 to Hawk titled “Baseball cap holder” is a plaque like structure for holding baseball caps by the button on the top of the cap, by the use of a U shaped. The cap bill extends forward from the structure, does not lay flat, and does not have a memorabilia display.
U.S. Pat. No. 5,865,333, issue Feb. 2, 1999 to Wolfe titled “Sports cap display” this is a shelf type of plaque that a single cap rest upon and is for displaying a cap having a bill affixed to a fully opened crown, this display uses a transparent inner and outer shells. This does not have a memorabilia display, nor is it designed for daily use.
U.S. Pat. No. 4,993,557, issue Feb. 19, 1991 to Davis titled “Cap storing device” this is a shelf type of plaque. A cap storage device adapted for supporting a plurality of caps, By the design a plurality of caps with their crowns folded may thus be stored one upon the other. This is not a vertical display for a single cap, visibility of caps uniqueness is not present nor does it have memorabilia display.
U.S. Pat. No. 5,022,515, issue Jun. 11, 1991 to Agostine titled “Hat container” related to containers for holding, storing, and transporting hats. This is not a vertical display nor does it have a memorabilia display.
U.S. Pat. No. 3,858,769, issue Jan. 7, 1975 to Billingslea, Jr. titled “Rolled Hat Brim Shaping Device” is to provide an economical and easily assembled, device for retaining the shape of the rolled brim portion of a cowboy hat. This design is not a vertical display, has no application to the cap, nor does it have memorabilia display.
U.S. Pat. No. 5,038,941, issue Aug. 13, 1991 to Bastiaansen titled “Hat rack”. This relates to a hat clamp and rack used for holding and displaying baseball-style caps. The cap does not lay flat nor does this design have a memorabilia display.
U.S. Pat. No. 5,630,516, issue May 20, 1997 to Helman titled “Ball Cap Display and Storage Rack Assembly” this device supports and stores a large number of ball caps by retaining the crown button of a ball cap. The cap is presented facing outward identically as seen when the cap is worn. The cap extends forward from the structure and does not have a memorabilia display.
U.S. Pat. No. 5,683,002, issue Nov. 4, 1997 to Rayside titled “Cap And Visor Organizer” A hat holder that is disclosed wherein a body comprises a plurality of slots based upon by a distance equal to a width of a hat brim. This structure is for home use; however, it does not meet the need for a single cap and does not have a memorabilia display.
U.S. Pat. No. 5,411,144, issue May 2, 1995 to Deupree Titled “Hat rack” is a cap rack in the form of an elongated bar that have slots having a width which has a fairly close tolerance to the thickness of the folded cap, design has rotational properties. This is not for displaying a cap nor does it have a memorabilia display
U.S. Pat. No. 5,762,206, issue Jun. 9, 1998 to Leichter titled “Cap rack” this cap rack comprises a base and a plurality of substantially flat hook, cap is hung by back band. This is not for a single cap display, nor does it have a memorabilia display

None of the above-related patents have the U-shaped strapping design that wraps around the front of the cap at the location the brim and top of the cap are joined.

### SUMMARY OF THE INVENTION

An apparatus; banner or plaque that is designed for holding and displaying Sports Caps, Photographs, Awards or other collectibles on a vertical plane. The apparatus includes tabs on top at either side to secure apparatus to a vertical plane. The soft display frame is produced by a transparent material in shape and size desired, that has been edged with a flexible material and permanently secured by the edges to the base of banner on 3(three) sides. This opening allows entry for items desired to be inserted securely. An attachment mechanism for the cap is a single strap, which is secured at both sides to base. Strap is connected at such points; as to allow the remainder of the strap to fall loosely to form a U shape. To secure the cap it is needed to fold the cap in half, from back to front; so that the back of the cap is nestling within the front of the cap and brim, and inserting the cap between base of banner and strap. The strap wraps around the front of the cap at the location the brim and top of the cap are joined. In this manner the cap is hung securely allowing easy viewing of cap, and will not cause any damage to cap being displayed. Using the design of the transparent display and U shaped strap formations; a variety of other banners can be produced.

### BRIEF DESCRIPTION OF THE DRAWINGS

The object of the present invention is to provide a banner or plaque for the display of baseball type cap, visors and Memorabilia.

Another object of the present invention is to provide such a banner or plaque which will securely retain the cap or memorabilia in a stable position.

Finally the object is to present invention is to provide such a banner or plaque; which will maintain the cap in a substantially vertical position with the entire front and top visible without deforming the cap.

FIG. 1 Front view perspective of the multi-functional sports banner.

FIG. 1 Mounted by use of tabs (A1/). These tabs have pre-set holes to secure to the vertical plane. (Shown in FIG. 5)

FIG. 1 Support unit structure slides in tube formed by sewing edges together (A2t and A2b). This is sealed after biased edge has been completed.

FIG. 1 Biased edge on both sides (left/right) of banner help to form a semi-rigid support to aid in banner remaining flat and not buckling (A3.)

FIG. 1 A transparent window (any desired shape), of a pliable plastic is trimmed by a semi rigid material (A4 & A5).

FIG. 1 This designated areas; are designed for uses of a logo, insignia, or decoration if desired. (A6t & A6b)

FIG. 1 Base of multi-functional sports banner (A7).

FIG. 1 U shaped flexible strap extension (consists of fabric, plastic or cording)(A8) for support of cap (E.I baseball, cap or visor) is secured to base at both ends of strap (A7).

FIG. 1 Memorabilia is secured within the transparent biased edge pocket A4 and A5. This is permanently secured on 3 sides to the base A7. The side that is left open can be the top or either left or right side of pocket structure to A4 and A5.

FIG. 1 Personalization of this banner can be done on top and/or bottom A6t and A6b as spacing has been available for it in construction. Whether personalized or not, invention is still pleasing to the eye and does not hinder its use.

FIG. 1 This area of base is a fold of material (double layer) and secured by seams noted by the dotted lines (A9t & A9b). A cross section perspective of side view of banner showing use of hard material inserts for structural support as indicated by A2t and A2b. This aspect shows the flatness of structure when secured on vertical plane.

FIG. 2 This drawing is a sample of the banner and its use.

FIG. 3 Side view displaying frame and cap placement. Displaying features flatness to structure.

FIG. 4 Left side view displaying frame and cap placement. Displaying features flatness to structure.

FIG. 5 A variation of U shaped flexible strap extensions used to display several caps only.

FIG. 6 A variation of U shaped flexible strap extensions and single window frame used to display several caps only.

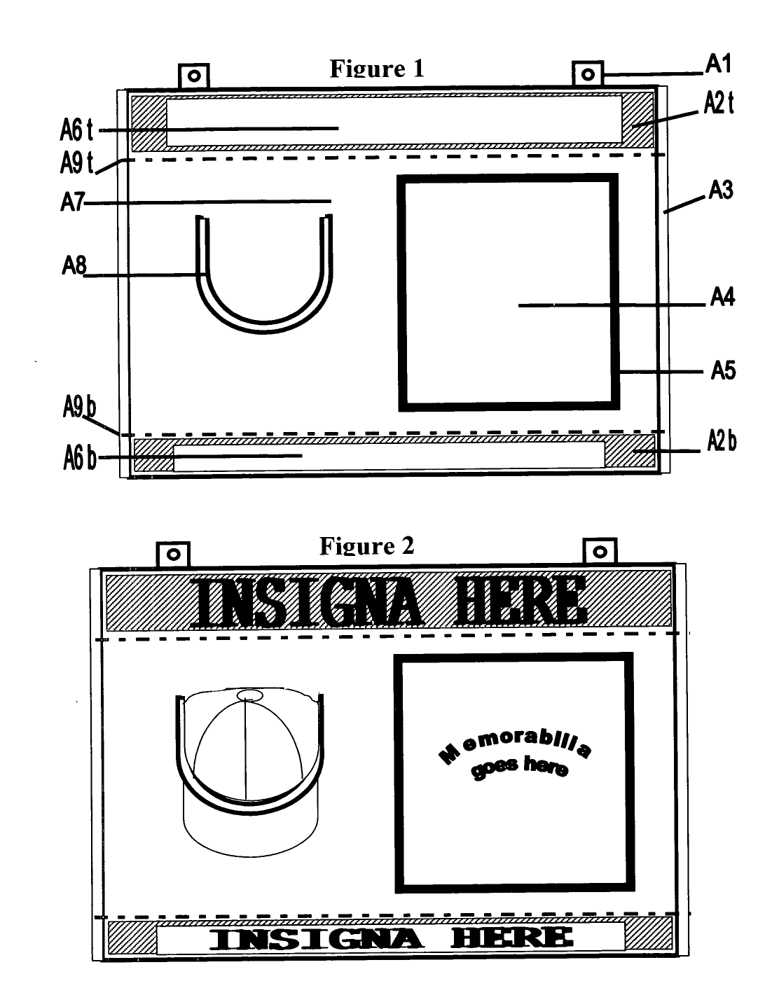

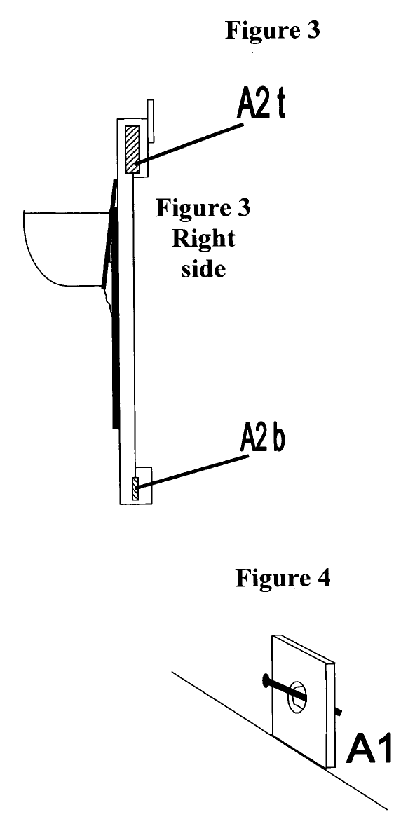

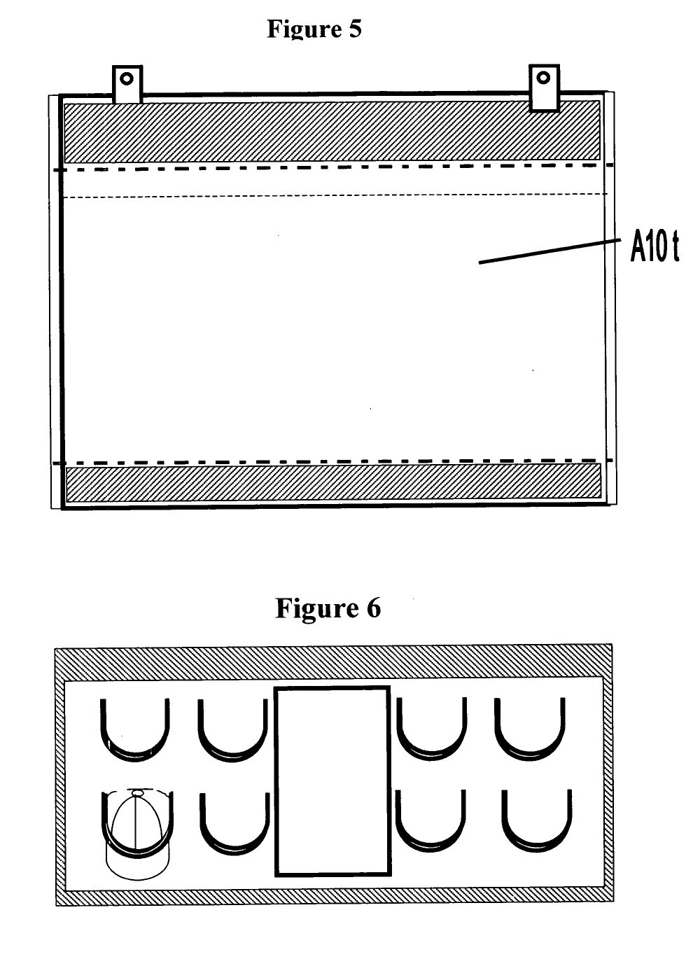

It will be understood that certain features and sub-combinations are of utility and may be employed without reference to other features and sub-combinations. This is contemplated by and is within the scope of the claims. (FIGS. 5 and 6)

Since many possible embodiments may be made of the invention without departing from the scope thereof, it is to be understood that all matter herein set forth or shown in the accompanying drawings is to be interpreted as illustrative, and not in a limiting sense.

What is claimed:

1. This banner apparatus, memorabilia or plaque designed is for holding and displaying a cap and collectibles. But is not limited to combinations of variations uses of said apparatus used to create varied designed structures to display multiples caps or collectibles.

2. Mounting apparatus for banner is 2(tabs structure) attached to the top back side at equal distance from edge of the base and are a flat surface front and back enabling them to secure banner to a vertical plane. The use of tabs is one method, but by design is not limited to any other conventional method that will secure a structure to a vertical plan.

3. The method of displaying a cap, is comprised by the steps of:
3.1. To secure cap it is needed to fold the cap in half, from back to front; so that the back of the cap is nestling within the front of the cap and brim, and inserting the cap between base of banner and strap.
3.2. The flexible strap wraps around the front of the cap at the location the brim and top of the cap are joined.
3.3. Cap is placed between the front vertical facing and the strap and is suspended pointing completely in a downward direction with the brim resting against the vertical base, allowing the full design on front and top of cap to be visible.
3.4. The baseball or other small item can rest inside the pocket create by the cap folding.
3.5. Cap rests securely and can not be damaged but is easily accessible.

4. The collectibles such as photograph, team schedules, team portrait, award, or other collectibles are stored in the display frame beside the hat assembly. This banner is portable, self contained and capable of being used in a wide variety of vertical planes.

5. Backside of banner can have an optional pocket for other collectibles for subject
